(19) United States
(12) Patent Application Publication
(10) Pub. No.: US 2012/0196069 A1
(43) Pub. Date: Aug. 2, 2012

(54) CAMOUFLAGED MILITARY OBJECT

(75) Inventors: Jean Daniel Boiteux, Neuhausen (CH); Lucca Degiorgi, Kreuzlingen (CH); Matthias Fries, Gaiennofenm (DE)

(73) Assignee: GENERAL DYNAMICS EUROPEAN LAND SYSTEMS-MOWAG GmbH

(21) Appl. No.: 13/100,649

(22) Filed: May 4, 2011

(30) Foreign Application Priority Data
May 12, 2010 (CH) 00739/10

(51) Int. Cl. B44C 1/10

(52) U.S. Cl. 428/39

(57) ABSTRACT

A camouflaged military object is equipped with a coating creating a camouflage pattern, which is formed with individual camouflage elements that can be added along to each other by hand. The form of the camouflage elements is based on at least one square having the same size, so that the camouflage elements can be added along at right angles to each other, as if creating a mosaic in an uninterrupted manner, in order to form a camouflage pattern. The camouflage elements can be joined together by using a plurality of layers which are formed from a magnetic foil, an intermediate layer made of insulating material, a color carrier foil, and a monochromatic color layer.

### BACKGROUND OF THE INVENTION

1. Field of the Invention

The invention relates generally to a camouflaged military object, which is provided with a camouflage pattern and which has a camouflaging layer attached to the surface of the object.

2. Related Art

Various methods are known from patent literature which can be used for the manufacturing, formation and mounting of patterns to a camouflaging layer or of a coating to an object. Patterning with dispersed distribution of per se repeated image elements is performed according to the camouflaging principle of a disrupted pattern, and this is known to persons in the art under the abbreviation DDP (Disrupted Digital Pattern). An example is described in WO 2009023783 and illustrated in US D 602,258 among many other bibliographic references. Another example of patterning is known from US 2010088797. According to these examples, pattern elements, which are provided with straight boundaries at right angles to each other and which have different colors, are rotated relative to each other and attached with screen printing onto foils or textile fabrics.

### SUMMARY OF THE INVENTION

Application of printing to uniform materials according to the DDP camouflage principle is widely used. However, the application of a corresponding color and pattern directly to the surface of vehicles, airplanes, ships and other military equipment is very demanding because spraying must be carried out with spraying technology in an enclosed space, and depending on the orientation of the relevant surface and on the flow conduct of the color, clean boundaries must be achieved between the pattern fields. For these reasons, similar patterns are printed according to photographic specifications onto self adhesive plastic foils, which are also per se known as being used on civilian vehicles for advertising purposes. A similar type of printing, however, results in considerable complications when the relevant camouflage pattern is supposed to be effective also in the infrared region because camouflage colors which are known under the description “infrared low emissivity,” for instance as disclosed in DE3123754, display a poor flow conduct, which is why they are not suitable for application with screen printing or with tampon printing.

Preliminary preparation of vehicle surfaces, as well as form-matched cutting and fitting attachment of such relatively large camouflage foils onto structure surfaces equipped with screw heads, hinges, levers and antennas and the like of a vehicle to be camouflaged are very labor intensive, which is why these operations must be therefore performed by specialized experts in factory halls. Accordingly, a modification of the camouflage pattern and of the coloring for adaptation to another field in which the vehicle is to be applied can be very expensive.

A goal of the present invention is to avoid the disadvantages connected with manufacturing of known camouflaged objects and thus to manufacture a camouflaged object of a camouflage pattern of the type described in the introduction in a significantly simpler manner.

This task is accomplished in accordance with the invention so that at least one part of the coating of the object to be camouflaged and its camouflage pattern are formed with individual camouflage elements which are added to each other by hand.

Further features and advantages of the present invention as well as the structure and operation of various embodiments of the present invention are described in detail below with reference to the accompanying drawings.

### BRIEF DESCRIPTION OF THE DRAWINGS

An embodiment of the present invention is described below with reference to the attached figures. The figures show the following:

FIG. 1 shows a lateral view of a military vehicle camouflaged in accordance with the invention; and

FIG. 2 shows a combination of eight forms used on a vehicle according to FIG. 1 of camouflage elements formed according to a uniform integrating principle.

### DETAILED DESCRIPTION OF THE PREFERRED EMBODIMENTS

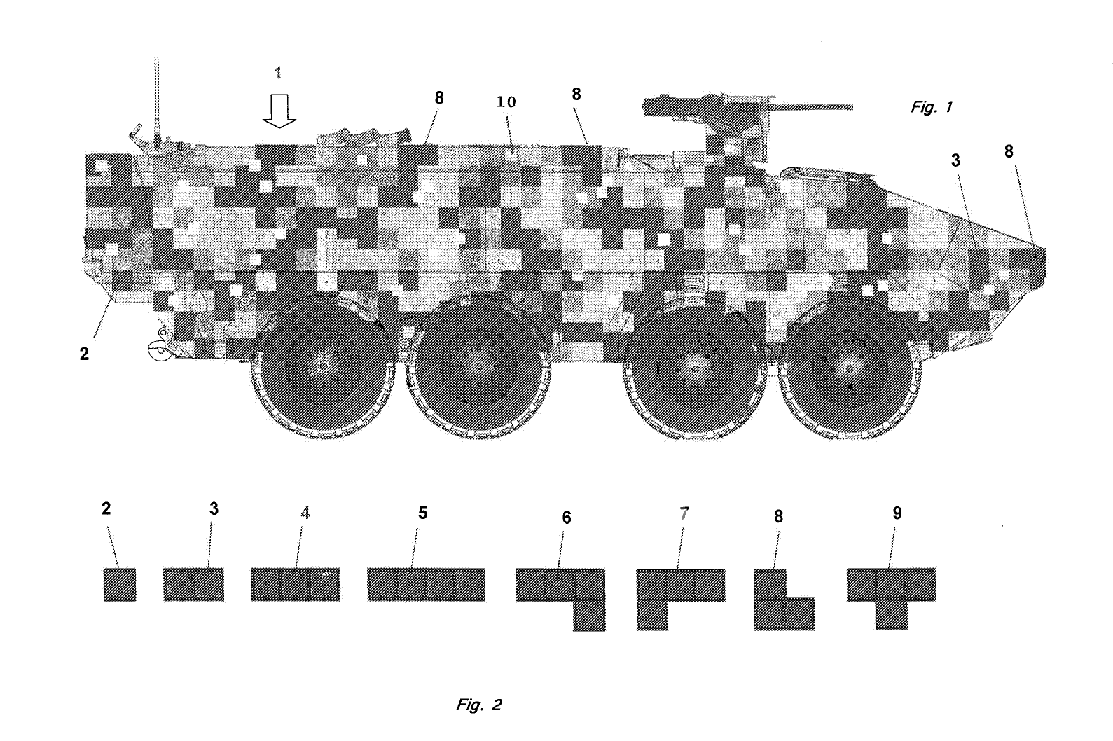

In order to produce camouflage for the vehicle 1 according to FIG. 1, eight different camouflage elements 2 through 9 having a single color were used in three different colors. Their form is created according to a uniform integrating principle, wherein each of the square base forms is created with the same size so as to correspond to the form of the smallest camouflage element 2. A similar group of elements formed according to the same principle is known in another application field also under the description “Tetris.”

The selection, which takes into account the different colors, and the arrangement and orientation of the camouflage elements 2 through 9 are carried according to the so-called DDP camouflage principle mentioned above, or a method for creating a camouflage pattern from disrupted image components, based on a photo, in a typical environment in which the vehicle to be camouflaged is moving, or in which the vehicle to be camouflaged is positioned.

It was found that relatively large squares 2 through 9 of the base form are sufficient according to this camouflage principle to produce a camouflage pattern in order to attain a realistic and adequate camouflage from a certain observation distance. The camouflage elements 2 through 9, which are to be attached by hand to the vehicle, can thus be based on a size of the squares which can be easily handled manually, wherein their lateral length is in the range of approximately 10 to 20 cm, and preferably 15 cm, so that the used camouflage elements 2 through 9 have a maximum length in the range from approximately 40 to 80 cm.

The different coloring of the camouflage elements 2 through 9, which is not visible due to the black and gray gradation shown in FIG. 1, corresponds to the use of these per se known camouflage colors, which are provided with optimal characteristics for the camouflage with respect to the color coordinates, the gloss level, the chemical and physical buildup of the color, and the infrared effect.

First, a base color of the camouflage is applied to the vehicle 1 to be camouflaged, for example with a spraying process. This base color is selected to match the territorial application field of the vehicle 1, and thus it can be for example a green color or a sand color. After that, the camouflaging elements 2 through 9 to be attached based on a camouflage pattern are attached to the vehicle according to the pattern shown in FIG. 1. Only certain regions will be in this case covered by the camouflage elements 2 through 9 according to the pattern, so that large regions will remain free and they will form one part of the camouflage pattern which is provided with the base color of the vehicle 1. This therefore makes it possible to retrofit older vehicles with camouflaging directly on the original base color of the vehicles.

The monochromatic design of the camouflage elements 2 through 9 provides a major advantage during the manufacturing, which makes it possible to avoid an expensive technical stage using a spraying or screen printing step because the application of monochromatic coloring can be performed with a carrier foil which can be unrolled from a roller in conventional manner, for example by using spraying or with a paint roller. The camouflage elements 2 through 9 are then cut out or punched out from such monochromatic foil material in accordance with their form.

The various image components are thus formed as if creating a mosaic which is assembled from the camouflage elements 2 through 9 by punching them out from as monochromatically produced foil material corresponding to the relevant color. When four colors are used for the structural elements of the pattern, for example black, green, brown and gray, which form a base color of the vehicle, three groups of respective camouflage elements 2 through 9 are provided for the camouflage layer.

The monochromatic layer of the foil material provided for the manufacturing of the camouflage elements 2 through 9 has on its lower side an adhesive layer which is customarily used with adhesive foils, so that the camouflage elements 2 through 9 can be attached directly on or to the surface of the vehicle 1 to be camouflaged and they can be then again removed from this surface.

The attachment of camouflage elements 2 through 9 for camouflaging of metallic surfaces, such as for example of armored vehicles, can be also realized magnetically, wherein the foil material described above is attached onto a magnetic sheet by means of an adhesive layer. Camouflage elements 2 through 9 that have been produced in this manner can then be used also in application areas involving retrofitting of a military vehicle 1, and they can be also used repeatedly.

For camouflages which are designed to be effective also in the infrared region, the camouflage elements 2 through 9 in accordance with the invention can be additionally painted for this purpose with an infrared color (IR, low emissivity color).

In addition, the camouflage elements 2 through 9 according to the invention can be provided with an intermediate layer which is made from a thermally insulating material. When combined with such an infrared color, such thermally insulating camouflage elements 2 through 9 improve the effect of the infrared camouflage for the regions on the surface of the vehicle in which increased temperatures are caused, for example as a result of the heat radiating from a motor of the vehicle.

In another embodiment form of the invention, additional elements 10 can be attached in order to reinforce the camouflaging effect, for example with an additional predetermined pattern of camouflage elements having a small size which are affixed to the surface of the vehicle.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

Having described the invention, what is claimed as new and secured by Letters Patent is:

1. A camouflaged military object equipped with a camouflage pattern, having a camouflaging layer adhering to the surface of the object, wherein at least one part of a coating of the object (1) to be camouflaged and its camouflage pattern is formed with individual camouflage elements (2-9) which are added to each other by hand.

2. The camouflaged object according to claim 1, wherein the camouflage elements (2-9) are arranged in an incomplete manner, so that a surface of the object (1) to be camouflaged forms a part of the camouflage pattern.

3. The camouflaged object according to claim 1, wherein respective camouflage elements (2-9) are monochromatic and are available in at least two colors.

4. The camouflaged object according to claim 1, wherein the form of the camouflage elements (2-9) is created from at least one square having the same size, so that the camouflage elements (2-9) can be added along in an uninterrupted manner with straight edges arranged at right angle to each other according to a predetermined pattern.

5. The camouflaged military object according to claim 4, wherein the camouflage elements (2-9) are available in different forms and sizes and their form, based on the minimum size of a camouflage element (2) having the form of a square, corresponds to joining together of up to four squares which have a uniform size.

6. The camouflage object according to claim 5, wherein the camouflage pattern comprises eight camouflage elements (2-9) which are different in form and size.

7. The camouflage object according to claim 1, wherein at least some of the camouflage elements (2-9) are equipped with a thermally insulating layer.

8. The camouflage object according to claim 1, wherein the camouflage elements (2-9) are equipped with an infrared camouflaging paint.

9. The camouflage object according to claim 1, wherein the camouflage elements (2-9) are attached to the object via an adhesive layer, which is removable from the surface of the object.

10. The camouflage object according to claim 9, wherein the camouflage elements (2-9) are attached so that they can be exchanged, via an inner layer which has a magnetic effect, to a metallic surface of the object (1).

11. Camouflage element for camouflaging a military object according to claim 1, wherein said camouflage element is provided with a monochromatic infrared camouflage paint and its form is created from at least one square with the same size, having a maximum lateral length of 20 cm, so that it can be added along to camouflaged elements (2-9) of the same type, which are formed with straight edges and which can be added mutually at right angle to each other in order to form a camouflage pattern.

12. The camouflage element according to claim 11, wherein said camouflage element is equipped with an intermediate layer which is made of a thermally insulating material.
